(19) United States
(12) Patent Application Publication
(10) Pub. No.: US 2025/0371785 A1
(43) Pub. Date: Dec. 4, 2025

(54) METHOD AND APPARATUS FOR GENERATING TRANSITION EFFECT IMAGE, DEVICE, AND STORAGE MEDIUM

(71) Applicant: Beijing Zitiao Network Technology Co., Ltd., Haidian District, Beijing (CN)

(72) Inventor: Ruchong Luo, Beijing (CN)

(21) Appl. No.: 18/874,028

(22) PCT Filed: Aug. 11, 2023
(86) PCT No.: PCT/CN2023/112480

§ 371 Date: Dec. 11, 2024

(30) Foreign Application Priority Data
Aug. 12, 2022 (CN) 202210968656.7

(51) Int. Cl. G06T 15/00

(52) U.S. Cl. CPC G06T 15/00

(57) ABSTRACT

A method and an apparatus for generating a transition effect image, a device, and a storage medium. 3D transformation information corresponding to a transition model at a current time instant is determined. The transition model is transformed based on the 3D transformation information, to obtain a transformed transition model. A pixel value is sampled from a set image based on the transformed transition model. A 3D transition effect image corresponding to the transition model is generated based on the pixel value.

The present application claims priority to Chinese Patent Application No. 202210968656.7, filed with the China National Intellectual Property Administration on Aug. 12, 2022, which is incorporated herein by reference in its entirety.

### FIELD

The present disclosure relates to the field of image processing technologies, and for example, to a method and apparatus for generating a transition effect image, a device, and a storage medium.

### BACKGROUND

When a plurality of video segments or a plurality of images are spliced, transition processing needs to be performed at a connection between the video segments or the images. A process of transition processing may be: first generating a plurality of transition images, splicing the plurality of transition images into a transition video, and setting the transition video between two video segments or between two images. In the related art, a generated transition image is of the two-dimensional (2D) effect, and a display effect is not rich enough.

### SUMMARY

The present disclosure provides a method and apparatus for generating a transition effect image, a device, and a storage medium, which can generate a transition effect image with a three-dimensional (3D) effect, to improve a display effect of transition.

An embodiment of the present disclosure provides a method of generating a transition effect image, including:
determining 3D transformation information corresponding to a transition model at a current time instant;
transforming the transition model based on the 3D transformation information to obtain a transformed transition model;
sampling a pixel value from a set image based on the transformed transition model; and
generating a 3D transition effect image corresponding to the transition model based on the pixel value.

An embodiment of the present disclosure further provides an apparatus for generating a transition effect image, including:
a 3D transformation information determining module configured to determine 3D transformation information corresponding to a transition model at a current time instant;
a transition model transformation module configured to transform the transition model based on the 3D transformation information to obtain a transformed transition model;
a pixel value sampling module configured to sample a pixel value from a set image based on the transformed transition model; and
a 3D transition effect image generation module configured to generate a 3D transition effect image corresponding to the transition model based on the pixel value.

An embodiment of the present disclosure further provides an electronic device, where the electronic device includes:
one or more processors; and
a storage apparatus configured to store one or more programs,
where the one or more programs, when executed by the one or more processors, cause the one or more processors to implement the method of generating a transition effect image according to the embodiment of the present disclosure.

An embodiment of the present disclosure further provides a storage medium including computer-executable instructions, where the computer-executable instructions, when executed by a computer processor, are configured to perform the method of generating a transition effect image according to the embodiment of the present disclosure.

### BRIEF DESCRIPTION OF THE DRAWINGS

FIG. 1 is a schematic flowchart of a method of generating a transition effect image according to an embodiment of the present disclosure;

FIG. 2a is an example diagram of a transition forward image according to an embodiment of the present disclosure;

FIG. 2b is an example diagram of a transition backward image according to an embodiment of the present disclosure;

FIG. 2c is an example diagram of a 3D transition effect image according to an embodiment of the present disclosure;

FIG. 2d is an example diagram of another 3D transition effect image according to an embodiment of the present disclosure;

FIG. 3 is a schematic structural diagram of an apparatus for generating a transition effect image according to an embodiment of the present disclosure; and

FIG. 4 is a schematic structural diagram of an electronic device according to an embodiment of the present disclosure.

### DETAILED DESCRIPTION OF EMBODIMENTS

The following describes embodiments of the present disclosure with reference to the accompanying drawings. Although some embodiments of the present disclosure are shown in the accompanying drawings, the present disclosure may be implemented in various forms and should not be construed as being limited to the embodiments set forth herein. Rather, these embodiments are provided for a thorough and complete understanding of the present disclosure. The accompanying drawings and embodiments of the present disclosure are only for exemplary purposes, and are not intended to limit the scope of protection of the present disclosure.

A plurality of steps described in the method implementations of the present disclosure may be performed in different orders and/or performed in parallel. In addition, additional steps may be included and/or execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

Concepts such as “first” and “second” mentioned in the present disclosure are only used to distinguish different apparatuses, modules, or units, and are not used to limit the order or interdependence of functions performed by these apparatuses, modules, or units.

References to “one”, “a plurality” in the present disclosure are illustrative rather than limiting, and should be understood as “one or more” unless the context clearly indicates otherwise.

Names of messages or information exchanged between a plurality of apparatuses in the implementations of the present disclosure are used for illustrative purposes only, and are not used to limit the scope of these messages or information.

Before a technical solution disclosed in a plurality of embodiments of the present disclosure is used, a user shall be informed of a type, a scope of use, a use scenario, and the like of personal information involved in the present disclosure in an appropriate manner in accordance with relevant laws and regulations and authorized by the user.

For example, when receiving an active request from a user, sending prompt information to the user to clearly prompt the user that an operation requested by the user will need to obtain and use personal information of the user. Therefore, the user can independently choose whether to provide personal information to software or hardware such as an electronic device, an application, a server, or a storage medium that executes the operation of the technical solution of the present disclosure according to the prompt information.

As an optional but non-limiting implementation, in response to receiving the active request from the user, the prompt information may be sent to the user in a pop-up window, and the prompt information may be presented in the form of text in the pop-up window. In addition, the pop-up window may further carry a selection control for the user to select “agree” or “disagree” to provide the personal information to the electronic device.

The above process of notifying and obtaining user authorization is only illustrative and does not limit the implementation of the present disclosure. Other methods that comply with relevant laws and regulations may also be applied to the implementation of the present disclosure.

Data involved in the technical solution (including the data per se, and acquisition or use of the data) shall comply with the requirements of corresponding laws, regulations, and related provisions.

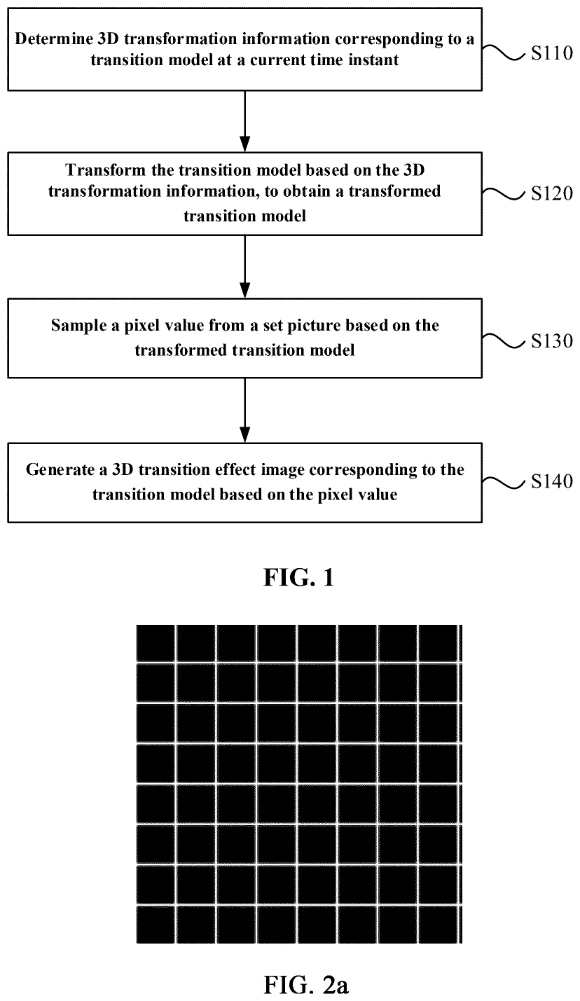

FIG. 1 is a schematic flowchart of a method of generating a transition effect image according to an embodiment of the present disclosure. The embodiment of the present disclosure is applicable to a case of generating a 3D transition effect image. The method may be performed by an apparatus for generating a transition effect image, which may be implemented in a form of software and/or hardware, and optionally, may be implemented by an electronic device, where the electronic device may be a mobile terminal, a personal computer (PC) terminal, a server, or the like.

As shown in FIG. 1, the method includes the following steps.

S110: 3D transformation information corresponding to a transition model at a current time instant is determined.

The transition model may be understood as a virtual model used for transition. In this embodiment, the transition model before transformation may be a 2D patch composed of four vertices. After being transformed by the 3D transformation information, a 3D transition model may be generated. The 3D transformation information may be information for performing 3D transformation on the transition model, and may be composed of perspective information, camera transformation information, and model transformation information.

For example, a method of determining the 3D transformation information corresponding to the transition model at the current time instant may be: obtaining the perspective information, and model transformation information and camera transformation information corresponding to the current time instant; and determining the 3D transformation information of the transition model based on the perspective information, the camera transformation information, and the model transformation information.

The model transformation information is transformation information of the transition model. The model transformation information (Model) may be understood as transformation information from a model space to a world space, and includes: model translation information, model scaling information, and model rotation information. The camera transformation information (View) may be understood as transformation information from the world space to a visual space, and includes: camera translation information, camera rotation information, and set component transformation information, where the set component transformation information may be that an inverted Z component (a default orientation of a camera is-Z). The perspective information (Projection) may be understood as transformation information from the visual space to a clip space.

Optionally, a process of obtaining the perspective information may be: obtaining virtual camera information; and generating the perspective information based on the virtual camera information.

The virtual camera information includes: viewing angle information, near plane information, far plane information, and screen ratio information. The near plane information may be a distance between a near plane of the camera and an optical center. The far plane information may be a distance between a far plane of the camera and the optical center. The screen ratio information may be a ratio of a width (W) to a height (H) of a screen. In this embodiment, the perspective information may be a 4×4 perspective matrix P. A method of generating the perspective information based on the virtual camera information may be: determining each element based on the virtual camera information, and forming the perspective matrix with a plurality of elements. For example, assuming that the viewing angle information is represented as fov, the near plane information is represented as N, the far plane information is represented as F, and the screen ratio information is represented as aspect, the perspective matrix is represented as:

$$P = [ \begin{matrix}\frac{cot ( \frac{fov}{2} )}{aspect} & 0 & 0 & 0 \\ 0 & cot ( \frac{fov}{2} ) & 0 & 0 \\ 0 & 0 & - \frac{F + N}{F - N} & - \frac{2 NF}{F - N} \\ & & - 1 & 0\end{matrix} ] .$$

In this embodiment, the perspective information is determined based on the viewing angle information, the near plane information, the far plane information, and the screen ratio information, which can improve accuracy of the perspective information.

Optionally, a method of obtaining the model transformation information and the camera transformation information corresponding to the current time instant may be: obtaining a transition progress corresponding to the current time instant; and determining the model transformation information and the camera transformation information corresponding to the current time instant based on the transition progress.

The transition progress is a ratio of a duration between the current time instant and a transition start time instant to a total transition duration. For example, assuming that the duration between the current time instant and the transition start time instant is t and the total transition duration is T, the transition progress may be represented as t/T.

In this embodiment, the model transformation information includes: model translation information, model scaling information, and model rotation information. A linear relationship or a non-linear relationship is presented between the model translation information and the transition progress, or the model translation information remains unchanged with the transition progress. A linear relationship or a non-linear relationship is presented between the model scaling information and the transition progress, or the model scaling information remains unchanged with the transition progress. A linear relationship or a non-linear relationship is presented between the model rotation information and the transition progress, or the model rotation information remains unchanged with the transition progress. For example, the model transformation information corresponding to the current time instant is determined based on a relationship between the transition progress and the model transformation information. The camera transformation information may include: camera translation information, camera rotation information, and set component transformation information. A linear relationship or a non-linear relationship is presented between the camera translation information and the transition progress, or the camera translation information remains unchanged with the transition progress. A linear relationship or a non-linear relationship is presented between the camera rotation information and the transition progress, or the camera rotation information remains unchanged with the transition progress. For example, the camera transformation information at the current time instant is determined based on a relationship between the transition progress and the camera transformation information. In this embodiment, the model transformation information and the camera transformation information corresponding to the current time instant are determined based on the transition progress, which can improve accuracy of the model transformation information and the camera transformation information.

Optionally, a method of determining the model transformation information corresponding to the current time instant based on the transition progress may be: determining model translation information, model scaling information, and model rotation information of the current time instant based on the transition progress; and determining the model transformation information based on the model translation information, the model scaling information, and the model rotation information.

The model translation information may include translation information along an x axis, translation information along a y axis, and translation information along a z axis, and may be represented as (tx, ty, tz). The model scaling information may include scaling information along the x axis, scaling information along the y axis, and scaling information along the z axis, and may be represented as (kx, ky, kz). The model rotation information may include rotation angles around the x axis, around the y axis, and around the z axis, and may be represented as (α, β, γ).

For example, a method of determining the model transformation information based on the model translation information, the model scaling information, and the model rotation information may be: determining a model translation matrix based on the model translation information, determining a model scaling matrix based on the model scaling information, determining a model rotation matrix based on the model rotation information, performing dot multiplication on the model translation matrix, the model rotation matrix, and the model scaling matrix to obtain a model transformation matrix, and using the model transformation matrix as the model transformation information.

The model translation matrix may be a 4×4 matrix, and a model translation matrix obtained from the model translation information may be represented as:

$$M 1 = [ \begin{matrix}1 & 0 & 0 & tx \\ 0 & 1 & 0 & ty \\ 0 & 0 & 0 & tz \\ 0 & 0 & 0 & 1\end{matrix} ] .$$

The model scaling matrix may be a 4×4 matrix, and a model scaling matrix obtained from the model scaling information may be represented as:

$$M 2 = [ \begin{matrix}kx & 0 & 0 & 0 \\ 0 & ky & 0 & 0 \\ 0 & 0 & kz & 0 \\ 0 & 0 & 0 & 1\end{matrix} ] .$$

The model rotation matrix may be a 4×4 matrix, and a model rotation matrix obtained from the model rotation information may be represented as:

$$M 3 = [ \begin{matrix}cos β \cdot cos γ & - cos β \cdot sin γ & sin β & 0 \\ cos α \cdot sin γ + sin α \cdot sin β \cdot cos γ & cos α \cdot cos γ - sin α \cdot sin β \cdot sin γ & - sin α \cdot cos β & 0 \\ sin α \cdot sin γ - cos α \cdot sin β \cdot cos γ & sin α \cdot cos γ + cos α \cdot sin β \cdot sin γ & cos α \cdot cos β & 0 \\ 0 & 0 & 0 & 1\end{matrix} ] .$$

The model transformation matrix may be represented as: M=M1·M2·M3 In this embodiment, the model transformation information is determined based on the model translation information, the model scaling information, and the model rotation information, which can improve accuracy of the model transformation information.

Optionally, a method of determining the camera transformation information corresponding to the current time instant based on the transition progress may be: determining camera translation information, camera rotation information, and set component transformation information of the current time instant based on the transition progress; and determining the camera transformation information based on the camera translation information, the camera rotation information, and the set component transformation information.

The camera translation information may include translation information along an x axis, translation information along a y axis, and translation information along a z axis, and may be represented as (vx, vy, vz). The camera rotation information may include rotation angles around the x axis, around the y axis, and around the z axis, and may be represented as (X, Y, Z). The set component transformation information may be a Z component that is inverted (a default orientation of a camera is −Z).

For example, a process of determining the camera transformation information based on the camera translation information, the camera rotation information, and the set component transformation information may be: determining a camera translation matrix based on the camera translation information, may determining a camera rotation matrix based on the camera rotation information, determining a Z component transformation matrix based on the set component transformation information, performing dot multiplication on the camera translation matrix, the camera rotation matrix, and the Z component transformation matrix to obtain a camera transformation matrix, and determining the camera transformation information based on the camera transformation matrix.

The method of determining the camera translation matrix based on the camera translation information may be similar to the process of determining the model translation matrix based on the model translation information in the foregoing embodiment, and details are not described herein again. The method of determining the camera rotation matrix based on the camera rotation information may be similar to the process of determining the model rotation matrix based on the model rotation information in the foregoing embodiment, and details are not described herein again. In this embodiment, the camera transformation information is determined based on the camera translation information, the camera rotation information, and the set component transformation information, which can improve accuracy of the camera transformation information.

In this embodiment, the perspective information is represented by a perspective matrix P, the camera transformation information is represented by a camera transformation matrix V, and the model transformation information is represented by a model transformation matrix M.

For example, a method of determining the 3D transformation information based on the perspective information, the camera transformation information, and the model transformation information may be: performing dot multiplication on the perspective matrix, the camera transformation matrix, and the model transformation matrix to obtain a 3D transformation matrix, and using the 3D transformation matrix as the 3D transformation information.

Assumes that the 3D transformation matrix is represented as MVP, and a process of determining the 3D transformation matrix may be represented as: MVP=P·V·M. In this embodiment, the 3D transformation information is obtained by performing dot multiplication on the perspective matrix, the camera transformation matrix, and the model transformation matrix, which can improve accuracy of the 3D transformation matrix.

S120: The transition model is transformed based on the 3D transformation information, to obtain a transformed transition model.

The transition model may be a 2D patch. The transition model may be composed of a set number of model vertices, and the set number may be 4. The model vertices may be represented by a vector with a size of 4×1. In this embodiment, coordinates of the four model vertices may be respectively represented as: A=(−1,−1, 0, 0), B=(1,−1, 0, 0), C=(−1, 1, 0, 0), and D=(1, 1, 0, 0).

For example, a method of transforming the transition model based on the 3D transformation information to obtain the transformed transition model may be: transforming a set number of model vertices based on the 3D transformation information, to obtain transformed model vertices; and forming the transformed transition model with the transformed model vertices.

The transforming the set number of model vertices based on the 3D transformation information may be: performing dot multiplication on a 3D transformation matrix corresponding to the 3D transformation information and coordinate information of the model vertices, to obtain the transformed model vertices. The transformed four model vertices may be represented as: A1=MVP·A, B1=MVP·B, C1=MVP·C, and D1=MVP·D

In this embodiment, the set number of model vertices are transformed based on the 3D transformation information, so that perspective, camera, and model transformation of the transition model can be implemented.

S130: A pixel value is sampled from a set image based on the transformed transition model.

The set image includes a transition forward image or a transition backward image. The transition forward image may be an image located before transition, and the transition backward image may be an image located after transition. Optionally, the set image may be any material image.

For example, a process of sampling the pixel value from the set image based on the transformed transition model may be: determining the set image based on the transition progress; obtaining mapping coordinate information of the transformed transition model; and sampling the pixel value from the set image based on the mapping coordinate information.

In this embodiment, a method of determining the set image based on the transition progress may be: determining the transition forward image as the set image if the transition progress is less than a set threshold; or determining the transition backward image as the set image if the transition progress is greater than or equal to the set threshold.

The set threshold may be any value set between ⅓ and ⅔. For example, the set threshold may be set to ½. For example, if the transition progress is less than the set threshold, the transition forward image is determined as the set image, that is, the pixel value is sampled from the transition forward image. If the transition progress is greater than or equal to the set threshold, the transition backward image is determined as the set image, that is, the pixel value is sampled from the transition backward image. In this embodiment, the set image is determined based on the transition progress, which can improve a display effect of the transition

A method of obtaining the mapping coordinate information of the transformed transition model may be: obtaining UV coordinates of the transformed model vertices. A method of sampling the pixel value from the set image based on the mapping coordinate information may be: performing interpolation processing on the UV coordinates of the model vertices to obtain UV coordinates of other pixel points in a UV mapping, and sampling the pixel value from the set image based on the UV coordinates of the plurality of pixel points in the UV mapping. In this embodiment, the 3D transition effect image is generated based on the transformed transition model, so that a transition effect image with a 3D perspective effect can be generated.

S140: A 3D transition effect image corresponding to the transition model is generated based on the pixel value.

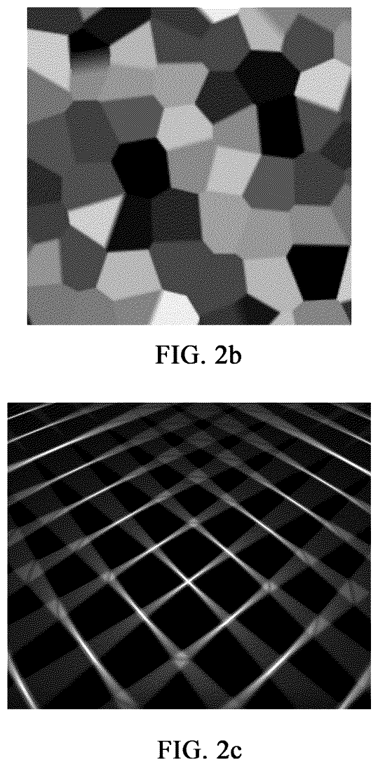

For example, a method of generating the 3D transition effect image corresponding to the transition model based on the pixel value may be: rendering the transition model based on the sampled pixel value, to obtain the 3D transition effect image. For example, FIG. 2a is an example diagram of a transition forward image according to this embodiment, FIG. 2b is an example diagram of a transition backward image according to this embodiment, and FIG. 2c to FIG. 2d are example diagrams of a 3D transition effect image according to this embodiment. As shown in FIG. 2c, the 3D transition effect image is a image obtained after pixel values are sampled from the transition forward image in FIG. 2a and rendering is performed, and the image has the 3D perspective effect. As shown in FIG. 2d, the 3D transition effect image is a image obtained after pixel values are sampled from the transition backward image in FIG. 2b and rendering is performed, and the image has the 3D perspective effect.

According to the technical solution of this embodiment of the present disclosure, 3D transformation information corresponding to a transition model at a current time instant is determined; the transition model is transformed based on the 3D transformation information, to obtain a transformed transition model; a pixel value is sampled from a set image based on the transformed transition model; and a 3D transition effect image corresponding to the transition model is generated based on the pixel value. According to the method of generating the transition effect image provided in this embodiment of the present disclosure, the transition model is transformed based on the 3D transformation information at the current time instant, and the pixel value is sampled from the set image based on the transformed transition model, so that the generated transition effect image has the 3D perspective effect, and a display effect of the transition image can be enriched.

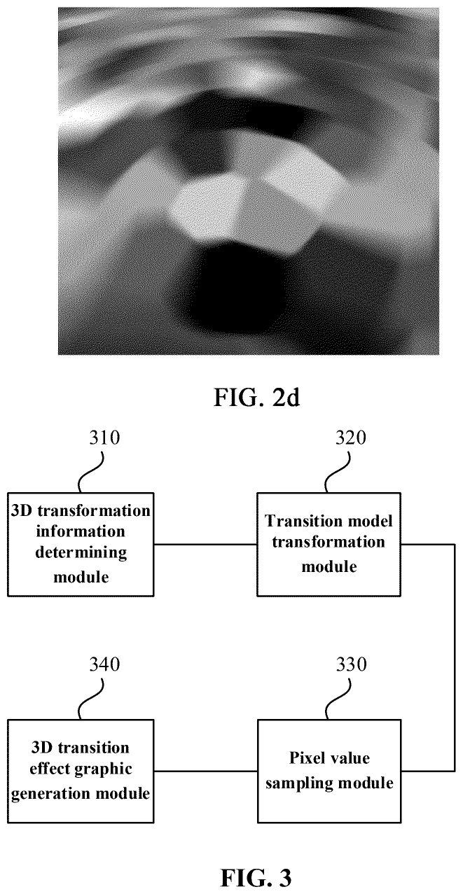

FIG. 3 is a schematic structural diagram of an apparatus for generating a transition effect image according to an embodiment of the present disclosure. As shown in FIG. 3, the apparatus includes the following modules.

A 3D transformation information determining module 310, configured to determine 3D transformation information corresponding to a transition model at a current time instant;
a transition model transformation module 320, configured to transform the transition model based on the 3D transformation information to obtain a transformed transition model;
a pixel value sampling module 330, configured to sample a pixel value from a set image based on the transformed transition model; and
a 3D transition effect image generation module 340, configured to generate a 3D transition effect image corresponding to the transition model based on the pixel value.

Optionally, the 3D transformation information determining module 310 is configured to:
obtain model transformation information and camera transformation information corresponding to the current time instant and perspective information, where the model transformation information is transformation information of the transition model; and
determine 3D transformation information of the transition model based on the perspective information, the camera transformation information, and the model transformation information.

Optionally, the 3D transformation information determining module 310 is configured to:
obtain virtual camera information, where the virtual camera information includes: viewing angle information, near plane information, far plane information, and screen ratio information; and generate the perspective information based on the virtual camera information.

Optionally, the 3D transformation information determining module 310 is configured to:
obtain a transition progress corresponding to the current time instant, where the transition progress is a ratio of a duration between the current time instant and a transition start time instant to a total transition duration; and
determine the model transformation information and the camera transformation information corresponding to the current time instant based on the transition progress.

Optionally, the 3D transformation information determining module 310 is configured to:
determine model translation information, model scaling information, and model rotation information of the current time instant based on the transition progress; and
determine the model transformation information based on the model translation information, the model scaling information, and the model rotation information.

Optionally, the 3D transformation information determining module 310 is configured to:
determine camera translation information, camera rotation information, and set component transformation information of the current time instant based on the transition progress; and
determine the camera transformation information based on the camera translation information, the camera rotation information, and the set component transformation information.

Optionally, the perspective information is represented by a perspective matrix, the camera transformation information is represented by a camera transformation matrix, and the model transformation information is represented by a model transformation matrix; and the 3D transformation information determining module 310 is configured to:
perform dot multiplication on the perspective matrix, the camera transformation matrix, and the model transformation matrix to obtain a 3D transformation matrix, and determining the 3D transformation matrix as the 3D transformation information.

Optionally, the transition model includes a set number of model vertices; and the transition model transformation module 320 is configured to:
transform the set number of model vertices based on the 3D transformation information, to obtain transformed model vertices, where the transformed model vertices form the transformed transition model.

Optionally, the pixel value sampling module 330 is configured to:
determine the set image based on the transition progress, where the set image includes
a transition forward image or a transition backward image;
obtain mapping coordinate information of the transformed transition model; and
sample the pixel value from the set image based on the mapping coordinate information.

Optionally, the 3D transition effect image generation module 340 is configured to:
render the transition model based on the sampled pixel value, to obtain the 3D transition effect image.

Optionally, the 3D transition effect image generation module 340 is configured to:
determine the transition forward image as the set image if the transition progress is less than a set threshold; or
determine the transition backward image as the set image if the transition progress is greater than or equal to the set threshold.

The apparatus for generating a transition effect image provided in this embodiment of the present disclosure may perform the method of generating a transition effect image provided in any embodiment of the present disclosure, and has corresponding functional modules and effects for performing the method.

The plurality of units and modules included in the foregoing apparatus are divided based on functional logic, but are not limited to the foregoing division, as long as corresponding functions can be implemented. In addition, names of the plurality of functional units are only intended to distinguish one from another, and do not limit the scope of protection of the embodiments of the present disclosure.

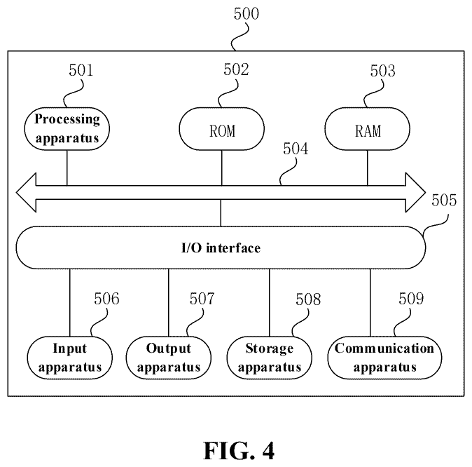

FIG. 4 is a schematic structural diagram of an electronic device according to an embodiment of the present disclosure. FIG. 4 shows a schematic structural diagram of an electronic device (for example, a terminal device or a server in FIG. 4) 500 suitable for implementing the embodiments of the present disclosure. The terminal device in this embodiment of the present disclosure may include a mobile terminal such as a mobile phone, a notebook computer, a digital broadcast receiver, a personal digital assistant (PDA), a tablet computer (PAD), a portable media player (PMP), and a vehicle-mounted terminal (for example, a vehicle navigation terminal), and a fixed terminal such as a digital TV (TV) and a desktop computer. The electronic device shown in FIG. 4 is merely an example, and shall not impose any limitation on the function and scope of use of the embodiments of the present disclosure.

As shown in FIG. 4, the electronic device 500 may include a processing apparatus (for example, a central processing unit and a graphics processing unit) 501, and the processing apparatus 501 may perform a plurality of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

The following apparatus may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; a storage apparatus 508 including, for example, a tape and a hard disk; and a communication apparatus 509. The communication apparatus 509 may allow the electronic device 500 to perform wireless or wired communication with other devices to exchange data. Although FIG. 4 shows the electronic device 500 having a plurality of apparatuses, it is not required to implement or have all of the shown apparatuses. It is possible to implement or have more or fewer apparatuses instead.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

Names of messages or information exchanged between a plurality of apparatuses in the implementations of the present disclosure are used for illustrative purposes only, and are not used to limit the scope of these messages or information.

The electronic device provided in this embodiment of the present disclosure is of the same concept as the method of generating a transition effect image provided in the foregoing embodiment. For technical details not described in detail in this embodiment, reference may be made to the foregoing embodiment, and this embodiment has the same effect as the foregoing embodiment.

An embodiment of the present disclosure provides a computer storage medium having a computer program stored thereon, where the computer program, when executed by a processor, implements the method of generating a transition effect image provided in the foregoing embodiment.

The computer-readable medium described above in the present disclosure may be a computer-readable signal medium, a computer-readable storage medium, or any combination thereof. The computer-readable storage medium may be, for example, electricity, magnetism, light, electromagnetism, infrared rays, or a semiconductor system, apparatus, or device, or any combination thereof. The computer-readable storage medium may include: an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including: electric wires, optical cables, radio frequency (RF), and the like, or any suitable combination thereof.

In some implementations, the client and the server may communicate using any currently known or future-developed network protocol such as the HyperText Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The foregoing computer-readable medium may be contained in the foregoing electronic device; or may exist independently without being assembled into the electronic device.

The foregoing computer-readable medium carries one or more programs that, when executed by the electronic device, cause the electronic device to: determine 3D transformation information corresponding to a transition model at a current time instant; transform the transition model based on the 3D transformation information, to obtain a transformed transition model; sample a pixel value from a set image based on the transformed transition model; and generate a 3D transition effect image corresponding to the transition model based on the pixel value.

The computer program code for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user through any kind of network, including a LAN or a WAN, or may be connected to an external computer (for example, connected through the Internet using an Internet service provider).

The flowcharts and block diagrams in the accompanying drawings illustrate the possibly implemented architecture, functions, and operations of the system, method, and computer program product according to the various embodiments of the present disclosure. In this regard, each block in the flowchart or block diagram may represent a module, program segment, or part of code, and the module, program segment, or part of code contains one or more executable instructions for implementing the set logical functions. In some alternative implementations, the functions marked in the blocks may also occur in an order different from those marked in the accompanying drawings. For example, two blocks shown in succession can actually be executed substantially in parallel, or they can sometimes be executed in the reverse order, depending on the functions involved. Each block in the block diagram and/or the flowchart, and a combination of the blocks in the block diagram and/or the flowchart may be implemented by a dedicated hardware-based system that executes set functions or operations, or may be implemented by a combination of dedicated hardware and computer instructions.

The units described in the embodiments of the present disclosure may be implemented by means of software, or may be implemented by means of hardware. The name of a unit does not constitute a limitation on the unit itself.

The functions described herein above may be performed at least partially by one or more hardware logic components. For example, example types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include an electronic, magnetic, optical, electromagnetic, infrared, or semiconductor system, apparatus, or device, or any suitable combination thereof. The machine-readable storage medium includes an electrical connection based on one or more wires, a portable computer disk, a hard disk, a RAM, a ROM, an EPROM, a flash memory, an optical fiber, a portable CD-ROM, an optical storage device, a magnetic storage device, or any suitable combination thereof. The storage medium may be a non-transitory storage medium.

According to one or more embodiments of the present disclosure, a method of generating a transition effect image is provided, including:
determining 3D transformation information corresponding to a transition model at a current time instant;
transforming the transition model based on the 3D transformation information, to obtain a transformed transition model;
sampling a pixel value from a set image based on the transformed transition model; and
generating a 3D transition effect image corresponding to the transition model based on the pixel value.

For example, determining 3D transformation information corresponding to a transition model at a current time instant includes:
obtaining model transformation information and camera transformation information corresponding to the current time instant and perspective information, where the model transformation information is transformation information of the transition model; and
determining the 3D transformation information of the transition model based on the perspective information, the camera transformation information, and the model transformation information.

For example, obtaining perspective information includes:
obtaining virtual camera information, where the virtual camera information includes: viewing angle information, near plane information, far plane information, and screen ratio information; and generating the perspective information based on the virtual camera information.

For example, obtaining the model transformation information and the camera transformation information corresponding to the current time instant includes:
obtaining a transition progress corresponding to the current time instant, where the transition progress is a ratio of a duration between the current time instant and a transition start time instant to a total transition duration; and
determining the model transformation information and the camera transformation information corresponding to the current time instant based on the transition progress.

For example, determining the model transformation information and the camera transformation information corresponding to the current time instant based on the transition progress includes:
determining model translation information, model scaling information, and model rotation information of the current time instant based on the transition progress; and
determining the model transformation information based on the model translation information, the model scaling information, and the model rotation information.

For example, determining the camera transformation information corresponding to the current time instant based on the transition progress includes:
determining camera translation information, camera rotation information, and set component transformation information of the current time instant based on the transition progress; and
determining the camera transformation information based on the camera translation information, the camera rotation information, and the set component transformation information.

For example, the perspective information is represented by a perspective matrix, the camera transformation information is represented by a camera transformation matrix, and the model transformation information is represented by a model transformation matrix; and determining the 3D transformation information based on the perspective information, the camera transformation information, and the model transformation information includes:
performing dot multiplication on the perspective matrix, the camera transformation matrix, and the model transformation matrix to obtain a 3D transformation matrix, and determining the 3D transformation matrix as the 3D transformation information.

For example, the transition model includes a set number of model vertices; and transforming the transition model based on the 3D transformation information to obtain the transformed transition model includes:
transforming the set number of model vertices based on the 3D transformation information to obtain transformed model vertices, where the transformed model vertices form the transformed transition model.

For example, sampling a pixel value from a set image based on the transformed transition model includes:
determining the set image based on the transition progress, where the set image includes a transition forward image or a transition backward image;
obtaining mapping coordinate information of the transformed transition model,
sampling the pixel value from the set image based on the mapping coordinate information.

For example, generating a 3D transition effect image corresponding to the transition model based on the pixel value includes:
rendering the transition model based on the pixel value to obtain the 3D transition effect image.

For example, determining the set image based on the transition progress includes:
determining the transition forward image as the set image if the transition progress is less than a set threshold; or
determining the transition backward image as the set image if the transition progress is greater than or equal to the set threshold.

Moreover, although a plurality of operations are depicted in a specific order, it should be understood as requiring these operations to be performed in the specific order shown or in a sequential order. Under specific circumstances, multitasking and parallel processing may be advantageous. Similarly, although a plurality of implementation details are included in the foregoing discussion, these details shall not be construed as limiting the scope of the present disclosure. Some features that are described in the context of separate embodiments can also be implemented in combination in a single embodiment. In contrast, a plurality of features described in the context of a single embodiment can also be implemented separately or in any suitable sub-combination in a plurality of embodiments.

Although the subject matter has been described in a language specific to structural features and/or logical actions of the method, the subject matter defined in the appended claims is not necessarily limited to the specific features or actions described above. In contrast, the specific features and actions described above are merely example forms for implementing the claims.

1. A method of generating a transition effect image, comprising:
determining 3-dimensional (3D) transformation information corresponding to a transition model at a current time instant;
transforming the transition model based on the 3D transformation information to obtain a transformed transition model;
sampling a pixel value from a set image based on the transformed transition model; and
generating a 3D transition effect image corresponding to the transition model based on the pixel value.

2. The method according to claim 1, wherein determining the 3D transformation information corresponding to the transition model at the current time instant comprises:
obtaining model transformation information and camera transformation information corresponding to the current time instant and perspective information, wherein the model transformation information is transformation information of the transition model; and
determining the 3D transformation information of the transition model based on the perspective information, the camera transformation information, and the model transformation information.

3. The method according to claim 2, wherein obtaining the perspective information comprises:
obtaining virtual camera information, wherein the virtual camera information comprises viewing angle information, near plane information, far plane information, and screen ratio information; and
generating the perspective information based on the virtual camera information.

4. The method according to claim 2, wherein obtaining the model transformation information and the camera transformation information corresponding to the current time instant comprises:
obtaining a transition progress corresponding to the current time instant, wherein the transition progress is a ratio of a duration between the current time instant and a transition start time instant to a total transition duration; and
determining the model transformation information and the camera transformation information corresponding to the current time instant based on the transition progress.

5. The method according to claim 4, wherein determining the model transformation information corresponding to the current time instant based on the transition progress comprises:
determining model translation information, model scaling information, and model rotation information of the current time instant based on the transition progress; and
determining the model transformation information based on the model translation information, the model scaling information, and the model rotation information.

6. The method according to claim 4, wherein determining the camera transformation information corresponding to the current time instant based on the transition progress comprises:
determining camera translation information, camera rotation information, and set component transformation information of the current time instant based on the transition progress; and
determining the camera transformation information based on the camera translation information, the camera rotation information, and the set component transformation information.

7. The method according to claim 2, wherein the perspective information is represented by a perspective matrix, the camera transformation information is represented by a camera transformation matrix, and the model transformation information is represented by a model transformation matrix; and determining the 3D transformation information of the transition model based on the perspective information, the camera transformation information, and the model transformation information comprises:
performing dot multiplication on the perspective matrix, the camera transformation matrix, and the model transformation matrix to obtain a 3D transformation matrix, and determining the 3D transformation matrix as the 3D transformation information.

8. The method according to claim 1, wherein the transition model comprises a set number of model vertices; and transforming the transition model based on the 3D transformation information to obtain a transformed transition model, comprises:
transforming the set number of model vertices based on the 3D transformation information to obtain transformed model vertices,
wherein the transformed model vertices form the transformed transition model.

9. The method according to claim 4, wherein sampling the pixel value from the set image based on the transformed transition model comprises:
determining the set image based on the transition progress, wherein the set image comprises a transition forward image or a transition backward image;
obtaining mapping coordinate information of the transformed transition model; and
sampling the pixel value from the set image based on the mapping coordinate information,
wherein generating the 3D transition effect image corresponding to the transition model based on the pixel value comprises:
rendering the transition model based on the pixel value to obtain the 3D transition effect image.

10. The method according to claim 9, wherein determining the set image based on the transition progress comprises:
determining the transition forward image as the set image in response to the transition progress being less than a set threshold;
determining the transition backward image as the set image in response to the transition progress being greater than or equal to the set threshold.

11. (canceled)

12. An electronic device, comprising:
one or more processors; and
a storage apparatus, configured to store one or more programs,
wherein the one or more programs, when executed by the one or more processors, cause the one or more processors to:
determine 3-dimensional (3D) transformation information corresponding to a transition model at a current time instant;
transform the transition model based on the 3D transformation information to obtain a transformed transition model;
sample a pixel value from a set image based on the transformed transition model; and
generate a 3D transition effect image corresponding to the transition model based on the pixel value.

13. A storage medium comprising computer-executable instructions, wherein the computer-executable instructions, when executed by a computer processor:
determine 3-dimensional (3D) transformation information corresponding to a transition model at a current time instant;
transform the transition model based on the 3D transformation information to obtain a transformed transition model;
sample a pixel value from a set image based on the transformed transition model; and
generate a 3D transition effect image corresponding to the transition model based on the pixel value.

14. The electronic device according to claim 12, wherein the one or more programs, when causing the one or more processors to determine the 3D transformation information corresponding to the transition model at the current time instant, cause the one or more processor to:
obtain model transformation information and camera transformation information corresponding to the current time instant and perspective information, wherein the model transformation information is transformation information of the transition model; and
determine the 3D transformation information of the transition model based on the perspective information, the camera transformation information, and the model transformation information.

15. The electronic device according to claim 14, wherein the one or more programs, when causing the one or more processors to obtain the perspective information, cause the one or more processor to:
obtain virtual camera information, wherein the virtual camera information comprises viewing angle information, near plane information, far plane information, and screen ratio information; and
generate the perspective information based on the virtual camera information.

16. The electronic device according to claim 14, wherein the one or more programs, when causing the one or more processors to obtain the model transformation information and the camera transformation information corresponding to the current time instant, cause the one or more processor to:
obtain a transition progress corresponding to the current time instant, wherein the transition progress is a ratio of a duration between the current time instant and a transition start time instant to a total transition duration; and
determine the model transformation information and the camera transformation information corresponding to the current time instant based on the transition progress.

17. The electronic device according to claim 16, wherein the one or more programs, when causing the one or more processors to determine the model transformation information corresponding to the current time instant based on the transition progress, cause the one or more processor to:
determine model translation information, model scaling information, and model rotation information of the current time instant based on the transition progress; and
determine the model transformation information based on the model translation information, the model scaling information, and the model rotation information.

18. The electronic device according to claim 16, wherein the one or more programs, when causing the one or more processors to determine the camera transformation information corresponding to the current time instant based on the transition progress, cause the one or more processor to:
determine camera translation information, camera rotation information, and set component transformation information of the current time instant based on the transition progress; and
determine the camera transformation information based on the camera translation information, the camera rotation information, and the set component transformation information.

19. The electronic device according to claim 14, wherein the perspective information is represented by a perspective matrix, the camera transformation information is represented by a camera transformation matrix, and the model transformation information is represented by a model transformation matrix; and the one or more programs, when causing the one or more processors to determine the 3D transformation information of the transition model based on the perspective information, the camera transformation information, and the model transformation information, cause the one or more processor to:
perform dot multiplication on the perspective matrix, the camera transformation matrix, and the model transformation matrix to obtain a 3D transformation matrix, and determining the 3D transformation matrix as the 3D transformation information.

20. The electronic device according to claim 12, wherein the transition model comprises a set number of model vertices; and the one or more programs, when causing the one or more processors to transform the transition model based on the 3D transformation information to obtain a transformed transition model, cause the one or more processor to:
transform the set number of model vertices based on the 3D transformation information to obtain transformed model vertices,
wherein the transformed model vertices form the transformed transition model.

21. The electronic device according to claim 16, wherein the one or more programs, when causing the one or more processors to sample the pixel value from the set image based on the transformed transition model, cause the one or more processor to:
determine the set image based on the transition progress, wherein the set image comprises a transition forward image or a transition backward image;
obtain mapping coordinate information of the transformed transition model; and
sample the pixel value from the set image based on the mapping coordinate information,
wherein generate the 3D transition effect image corresponding to the transition model based on the pixel value comprises:
render the transition model based on the pixel value to obtain the 3D transition effect image.
